(19) United States
(12) Patent Application Publication
(10) Pub. No.: US 2008/0140570 A1
(43) Pub. Date: Jun. 12, 2008

(54) METHOD AND SYSTEM FOR RENTING VEHICLES

(75) Inventor: Garfield W. Vaughn, South Windsor, CT (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/608,532

(22) Filed: Dec. 8, 2006

(51) Int. Cl. H04K 1/00; H04Q 5/22

(52) U.S. Cl. 705/50; 340/10.4

(57) ABSTRACT

Disclosed are a method and system for supporting self-service vehicle rental. An auto renter creates and manages a profile on-line and makes a reservation on-line. When the reservation is made, a confirmation code is e-mailed to the renter. In one embodiment of the present invention, a device is installed in a rental vehicle and the renter must enter both the confirmation code4 and a user passcode into the device to initiate rental of the vehicle. In another embodiment of the present invention, as the renter drives the vehicle through an exit gate, a departure location tag (e.g., RFID Tag), records the time the vehicle leaves the parking lot. The user passcode may be used as a key to start the vehicle subsequently. When the renter is ready to return the vehicle, an arrival location tag triggers recordation of the time the vehicle passes through a return gate. The tag triggers recordation of the time the vehicle passes through a return gate. The device will display rental information including miles driven, fuel level and cost allowing the renter to print or e-mail a receipt to complete the rental process.

1. Field of the Invention

This invention generally relates to vehicle rental systems; and more specifically, the invention relates to methods and systems for supporting self-service vehicle rental.

2. Background Art

In the current state of the art, vehicle rentals, and in particular automobile or car rentals require an initial check-in or rental procedure wherein the lessee provides personal and financial payment information (usually a credit card number and charge authorization) to the rental agency at a check-in counter. The information is then linked by computerized record to an available vehicle, using identification such as the vehicle license plate number, Vehicle Identification Number (VIN) and the like. Before each new rental, the vehicle is inspected for current odometer reading and fuel level (with such information being entered in the computer database or its having already been previously entered with a prior return). This information is entered on a rental agreement and given to the customer and payment is effected, which, for individuals, is almost always with the tendering of a credit card.

The identified vehicle is located in the lot by the customer and then removed from the rental agency lot with a gate security check at a checkout gate, as assurance that the driver is in fact the authorized lessee, or is otherwise authorized to remove the vehicle from the lot. Usually this is effected by comparison of driver identification with a rental agreement or just with the rental agreement information.

Thereafter the vehicle is driven and eventually returned to a rental agency lot (the origination lot or another lot of the same rental agency in a different location when such type of return is authorized) and the lessee advises the agency of such return.

Prior to completion of the checkout, an employee of the rental agency may be dispatched to physically inspect the vehicle and to check the mileage (many rental agreements are dependent on mileage) and fuel level (the usual agreement specifies that returns are to have a full tank, and if not, an additional fuel charge is applied). In some instances, the results are entered into a hand held computerized recordation device for entry into the agency computer database for calculation of the final rental charge (either while the lessee waits or as a supplement to the original charge on the initially tendered credit card). In other instances, the information is collected from the vehicle and is manually entered into a computer database for calculation of the final charges.

The present system has several shortcomings. One very important disadvantage is the wait the customers often endure both when renting and when returning the vehicle. Having to wait in a queue when renting or returning a vehicle can be a very time consuming process. Depending on how long it takes may determine if the customer makes or misses an airline flight. Having to depend on car rental agents to process the rental agreement is unnecessary.

### SUMMARY OF THE INVENTION

An object of this invention is to provide a self-service vehicle rental and return system.

Another object of the invention is to allow the renter of a vehicle to completely process the rental or return of the vehicle without the assistance of an auto rental agent.

A further object of the present invention is to allow vehicle renters to reduce the time spent in a queue when initially picking up or returning a rented vehicle.

These and other objectives are attained with a method and system for self-service vehicle rental. Generally, in this method and system, a person will define a personal profile that will contain contact and other information about the person. The profile can be created by the user via a web site or created by a rental agent. Using the data from the user's profile in addition to RFID technology, a solution that allows an auto renter to rent an automobile without depending on a human to process any part of the rental agreement can be enabled.

This solution will allow the millions of auto renters to reduce the time spent in a queue when initially picking up or returning a rented vehicle. This is a competitive advantage for auto rental agents.

More specifically, in the preferred embodiment of the invention, an auto renter creates and manages a profile on-line and makes a reservation on-line. When the reservation is made, a confirmation code is e-mailed to the renter. In one embodiment of the present invention, a device is installed in a rental vehicle and the renter must enter both the confirmation code and a user passcode into the device to initiate rental of the vehicle. In another embodiment of the present invention, the device captures the entered data and a photo of the renter for identification purposes and sends the information through a wireless network to a centralized repository. In yet another embodiment of the present invention, as the renter drives the vehicle through an exit gate, a departure location tag (e.g., RFID Tag), records the time the vehicle leaves the parking lot. The user passcode may be used as a key to start the vehicle subsequently. When the renter is ready to return the vehicle, an arrival location tag triggers recordation of the time the vehicle passes through a return gate. The device will display rental information including miles driven, fuel level and cost allowing the renter to print or e-mail a receipt to complete the rental process.

Further benefits and advantages of his invention will become apparent from a consideration of the following detailed description, given with reference to the accompanying drawings, which specify and show preferred embodiments of the invention.

### BRIEF DESCRIPTION OF THE DRAWINGS

FIG. 1 schematically represents a vehicle rental system.

FIG. 2 illustrates the interior of an automobile modified in accordance with the present invention.

FIGS. 3 and 4 are flow charts showing a preferred method of implementing this invention.

### DETAILED DESCRIPTION OF THE PREFERRED EMBODIMENTS

The present invention provides a method and system for supporting self-service vehicle rental. Generally, a person will define a personal profile that will contain contact and other information about the person. The profile can be created by the user via a web site or created by a rental agent. Using the data from the user's profile in addition to REID technology, a solution that allows a vehicle renter to rent a vehicle without depending on a human to process any part of the rental agreement can be enabled.

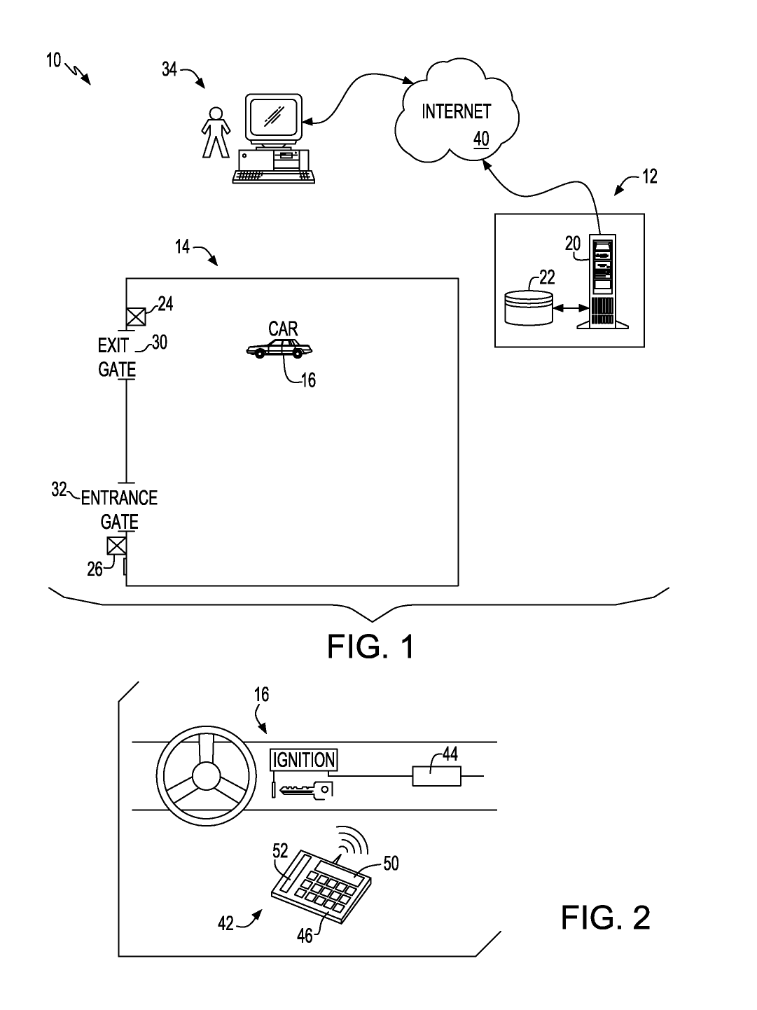

FIG. 1 generally illustrates a vehicle rental system 10 operated in accordance with this invention. In particular, FIG. 1 shows a vehicle rental agency, represented at 12, a rental lot 14, and a vehicle 16 in that rental lot. The rental agency includes a server and a data storage device 22, and RF transmit/receive units, represented at 24 and 26, are located at both the exit and return gates 30, 32 of the rental lot. FIG. 1 also shows a user or lessee 34. Both the rental agency server, and the user are connected to the Internet 40.

FIG. 2 shows the interior of vehicle 16, and as illustrated therein, the vehicle includes a data input/processing device 42, and a transmit/receive unit 44. Generally, device 42 includes a data entry keyboard 46 and a screen 50 for direct entry by the customer of identification and rental information. Device 42 may also include a credit card reader 52. Transmit/receive unit 44 may transmit the customer entered information, including possibly credit cared information, to a central billing and control database.

Preferably, the vehicle further includes odometer reading sensor means linked to an odometer of the vehicle for the storage of odometer readings of the vehicle mileage and for the remote transmission thereof to a data collection or central billing database. The vehicle preferably further comprises fuel sensor means linked to the vehicle's float sensor normally used for gauging fuel level in a vehicle's fuel tank. Other connections from the transceiver/receiver device to car functions (which may be unrelated to direct billing information) may be effected such as with oil pressure and water temperature sensors.

In the preferred implementation of the invention, a user will define a profile that contains information like: Company Information, Address Information, Phone Numbers, E-Mail Addresses, Preferences, and Likes and Dislikes.

Once a user defines a profile, they will receive a passcode that can be altered by the user. The user will be able to maintain any information of their profile at any time. Upon making a reservation (via assistance or self serve), the user will receive an e-mail confirming the reservation. At the time of pickup, a vehicle will be assigned to the renter. When the assignment is initially made, a relationship will be created (stored in a dB) with the vehicle identifier/confirmation code/ passcode/start date/time and end date/time.

When the user enters the vehicle for the first time, they will be required to enter their passcode and the confirmation code. Without both, the car will not start initially. After the initial start, the driver will only be required to enter their passcode. Once the renter drives the vehicle off the lot, the REID tag associated with the vehicle will capture the date and time that the vehicle left the lot then the number of miles and the amount of fuel. On return to the lot, the REID tag associated with the vehicle captures the return date and time, miles and the amount of fuel. The renter can immediately see the total cost of the rental on the display device installed in the vehicle. Have the option of printing a receipt or sending an e-mail of the receipt to the e-mail address on file.

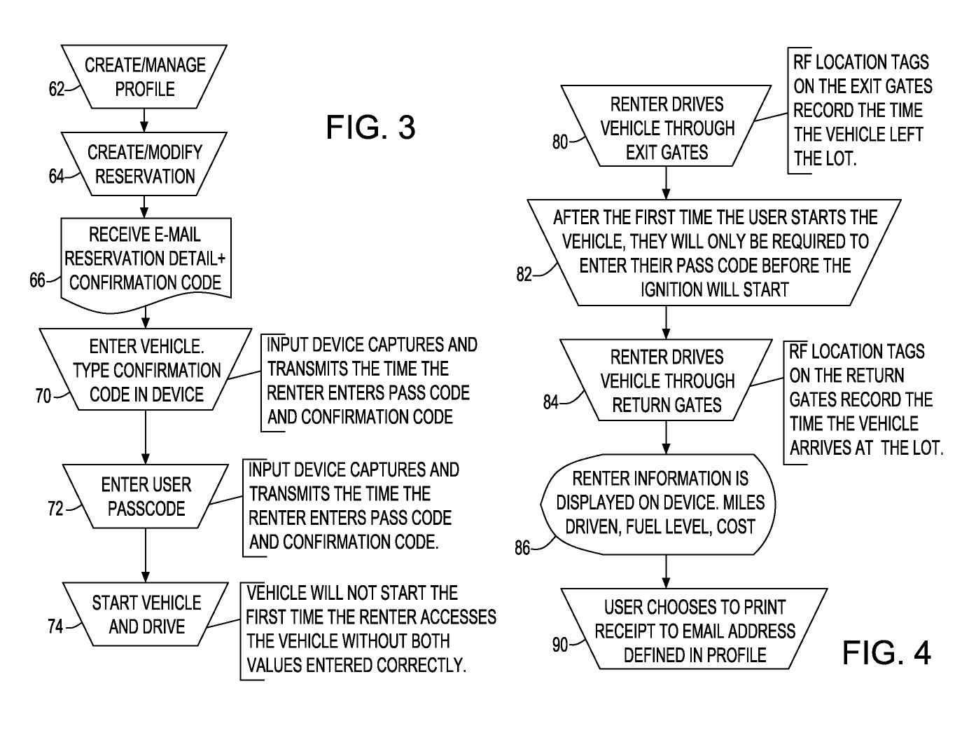

FIGS. 3 and 4 illustrate a preferred implementation of the present invention. At step 62, the user creates and manages his or her profile. As mentioned above, this profile may include information such as company information, address information, phone numbers, e-mail addresses, preferences, and likes and dislikes. At step 64, the user creates, and has the ability to modify, a reservation for a vehicle. After the reservation is created, the rental agency, at step 66, sends an e-mail to the user, and this email includes details of the reservation and a confirmation code.

At steps 70 and 72, the user enters the vehicle and enters the confirmation code and the user pass code into input device 42. This input device captures and transmits the time the renter enters the pass code and confirmation code. Then, at step 74, the renter starts the vehicle. The first time the renter accesses the vehicle; the vehicle will not start without both the pass code and the confirmation code entered correctly.

With reference to FIG. 4, at step 80, the renter drives the vehicle through the exit gate. RF location tags on the exit gate record the time the vehicle leaves the lot. As represented by step 82, after the first time the user starts the vehicle, the user is only required to enter his or her pass code before the ignition will start.

At step 84, the renter, when returning the vehicle, drives the vehicle through the return gate. When this happens, RF location tags on the return gate record the time the vehicle arrives at the lot. At step 86, rental information is displayed on input device 42. This information may include, for example, miles driven, and fuel level and cost. At step 90, the user prints a receipt or emails a receipt for the rental of the vehicle, to the email address stored in the user profile.

The preferred embodiment of the invention, as described above in detail, provides a number of important advantages. For example, the invention allows the millions of auto renters to reduce the hours spent in a queue when initially picking up or returning a rented vehicle. This is a competitive advantage for auto rental agencies.

As will be readily apparent to those skilled in the art, the present invention, or aspects of the invention, can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

Also, the present invention, or aspects of the invention, can also be embodied in a computer program product, which comprises all the respective features enabling the implementation of the methods described herein, and which—when loaded in a computer system —is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of self-service vehicle rental, comprising the steps of:
a user creating a user profile and sending the profile over the Internet to a database of a vehicle rental agency, said profile including a user pass code;
the user making a reservation over the Internet, with the vehicle rental agency to rent a vehicle;
in response to said user making the reservation, the vehicle rental agency sending a confirmation of the reservation to the user via email, said confirmation including a confirmation code;
pursuant to the reservation to rent the vehicle, the user entering a specified vehicle;
after entering the specified vehicle and before driving the vehicle a first time, the user entering into an input device for a first time both the user pass code and the confirmation code;
said device processing the entered pass code and confirmation code, and if the entered pass code and confirmation code are both correct, said input device electronically enabling starting of the specified vehicle;
said user starting and then driving the specified vehicle the first and subsequent times; and
before driving the specified vehicle each of said subsequent times, (i) the user re-entering into the input device the user pass code, (ii) the input device processing the re-entered user pass code and, if the re-entered pass code is correct, said input device electronically enabling re-starting of the specified vehicle, and (iii) the user then re-starting the specified vehicle, wherein in order to enable said re-starting, the user is only required to re-enter the user pass code into the input device.

2. A method according to claim 1, comprising the further steps of:
the input device capturing and sending to said database the time when the user enters into the input device for the first time both the user pass code and the confirmation code; and
the input device capturing and sending to said database the time whenever the user re-enters into the input device the user pass code.

3. A method according to claim 2, comprising the further step of, before the user starts the car the first time, the input device capturing a photographic image of the user and sending said photographic image through a wireless network to a centralized repository.

4. A method according to claim 3, wherein the specified vehicle is initially located in a defined area having an exit gate and a return gate, a first RF location tag is on the exit gate, and a second RF location tag is on the return gate, and the method comprises the further steps of:
the user driving the specified vehicle through the exit gate;
the first RF location tag recording the time the specified vehicle is driven through the exit gate;
the user driving the car through the return gate to return the vehicle to the defined location; and
the second RF location tag recording the time the specified vehicle is driven through the return gate.
